(19) United States
(12) Patent Application Publication
(10) Pub. No.: US 2007/0284326 A1
(43) Pub. Date: Dec. 13, 2007

(54) ELASTIC STRAP HOLDING APPARATUS AND METHOD

(76) Inventor: Perry Baloun, Highmore, SD (US)

Correspondence Address: SCHWEGMAN, LUNDBERG & WOESSNER, P.A., P.O. BOX 2938, MINNEAPOLIS, MN, 55402, US

(21) Appl. No.: 11/684,451

(22) Filed: Mar. 9, 2007

Related U.S. Application Data
(60) Provisional application No. 60/780,744, filed on Mar. 9, 2006.

(51) Int. Cl. B25H 3/04

(52) U.S. Cl. 211/182

(57) ABSTRACT

An elastic strap storage apparatus including a first set of cross members, and a second set of cross members attached to the first set of cross members. The first set of cross members and the second set of cross members have stops on each end of the cross member.

### RELATED APPLICATIONS

This patent application claims the benefit of priority, under 35 U.S.C. Section 119(e), to U.S. Provisional Patent Application Ser. No. 60/780,744, filed on Mar. 9, 2006, which is incorporated herein by reference.

### BACKGROUND

Elastic straps come in many styles and sizes. Generally, the elastic straps have a hook or other retention device on one end. Many elastic straps have a hook or other retention device on each end of the strap. One common form of an elastic strap is commonly referred to as a bungee cord. The bungee cord includes an open ended hook at each end of an elastic material. There are several problems associated with storing bungee cords. One problem is that the open ended hook ends tend to become entangled with other open ended hook ends or even other devices. The open-ended hook on the end can become ensnared in any number of devices. For example, if a user throws a bungee cord into a tool box, the open-ended hook can hook onto an opening in the handle of an adjustable crescent wrench. If bungee cords are stored with one another, the open-ended hook ends become snared or entangled with one another. In some applications, it is necessary to have a relatively large number of bungee cords or elastic straps stored together. One such application is in the trucking industry where a large number of elastic straps, called tie-downs, are used to hold down a tarp or canvas covering over a load on a flatbed trailer. Removing the tie downs or elastic straps from a storage container becomes a time consuming portion of placing a tarp onto a load since a large amount of time is needed to untangle the stored tie-downs. In some instances, the untangling of a large number of tie-downs can take 15-30 minutes. This is serious, as a trucker would rather be on the road moving toward his or her destination rather than spending time untangling straps.

Of course it should be pointed out that there are many other examples of time spent untangling elastic straps. For example, boat owners have the same issues when using elastic straps to tie down a boat cover. Campers may have similar issues. Bike owners also use these straps. Therefore, there are many users of elastic straps of different types that would rather spend their time doing something else than untangling straps.

### BRIEF DESCRIPTION OF THE DRAWINGS

The invention is pointed out with particularity in the appended claims. However, a more complete understanding of the present invention may be derived by referring to the detailed description when considered in connection with the figures, wherein like reference numbers refer to similar items throughout the figures, and:

FIG. 1 is a perspective view of an elastic strap storage apparatus, according to an example embodiment.

FIG. 2 is a top view of an elastic strap storage apparatus, according to an another example embodiment.

FIG. 3 is a is a perspective view of an elastic strap storage apparatus, according to an yet another example embodiment.

FIG. 4 is a perspective view of an elastic strap storage apparatus, according to an example embodiment.

FIG. 5 is a top view of an elastic strap storage apparatus, according to an example embodiment.

FIG. 6 is a top view of an elastic strap storage apparatus with elastic straps attached, according to an another example embodiment.

FIG. 7 is a top view of an elastic strap storage apparatus with elastic straps attached, according to an yet another example embodiment.

FIG. 8 is a flow chart of a method for using an elastic strap storage apparatus, according to an example embodiment.

FIG. 9 is a flow chart of a method for using an elastic strap storage apparatus, according to an example embodiment.

FIG. 10 is a front view of an elastic strap storage apparatus kit, according to an example embodiment.

FIG. 11 is a back view of an elastic strap storage apparatus kit, according to an example embodiment.

The description set out herein illustrates the various embodiments of the invention, and such description is not intended to be construed as limiting in any manner.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural changes may be made without departing from the scope of the present invention. The following description is, therefore, not to be taken in a limited sense, and the scope of the present invention is defined by the appended claims.

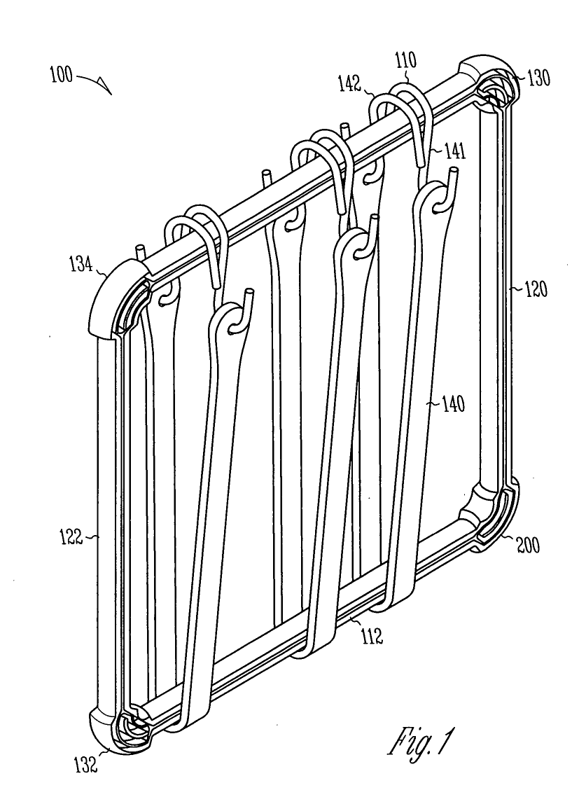

FIG. 1 is a perspective view of an elastic strap storage apparatus 100, according to an example embodiment. The elastic strap apparatus 100 includes a first cross member 110 and a second cross member 112. Cross member 110 and the cross member 112 are substantially parallel to one another and form a first set of cross members which are spaced apart by a selected distance. The elastic strap storage apparatus 100 also includes a third cross member 120 and a fourth cross member 122. The cross members 120 and 122 form a second set of cross members that are spaced apart from each other by a selected distance. The second set of cross members 120, 122 is attached to the first set of cross members 110, 12. As shown in the embodiment of FIG. 1, the first set of cross members 110, 112 is attached to the second set of cross members 120, 122 at the corners of the elastic strap storage apparatus 100. Each of the corners is enlarged with respect to the cross members so as to act as a stop. The stops, which also correspond to the corners, carry the reference numerals 130, 131, 132 and 134. The stops 130 are sized so that they are of a larger diameter than a hook on an elastomeric strap. As shown in FIG. 1, several elastic straps are attached to the storage apparatus 100. Elastic straps, such as the elastic strap 140, includes an elastic portion 140 as well as a hook 141 attached at one end of the strap and a second hook 142 attached at the other end of the strap. As shown in FIG. 1, the elastomeric strap 140 and specifically the hook 141 and the hook 142 are attached to the cross member 110. The end or corner or stop 130 has a diameter which is larger than the diameter associated with the hook 141 or 142. Thus, the stop or end or corner 130 will prevent the hooks 141 and 142 from sliding off the end of the cross member 110. As shown, the corner 131 and corner 132 also prevent the strap from sliding off of the end of the cross member 112. It should be noted that the distance between the first cross member 110 and the second cross member 112 is approximately half the length of the strap 140. The selected distance between the cross members 110 and 112 is of a sufficient distance so that a standard sized strap will have to be slightly stretched when one hook is a hook of an elastic strap 140 is placed on the member 110 and wrapped around cross member 112 and the other hook 142 is attached to the cross member 110. When the strap 140 or specifically the elastomeric portion of the strap 140 is tensioned slightly, this helps the strap to stay in place on the elastic strap storage apparatus 100.

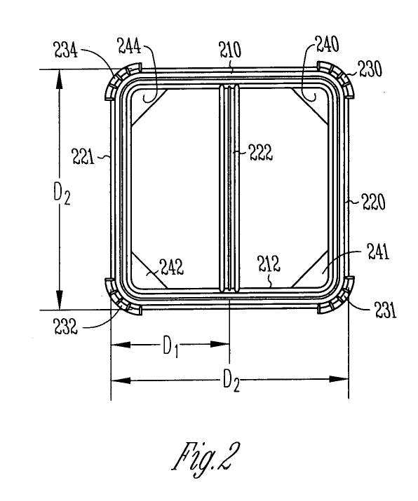

FIG. 2 is a perspective view of an elastic strap apparatus 200, according to another example embodiment. The elastic strap storage apparatus 200 includes a first cross member 210, a second cross member 212, as well as a third cross member 220, a fourth cross member 221, and a fifth cross member 222. Cross members 210 and 212 are attached to the cross members 220, 221 and 222. Cross member 210, cross member 212 are attached to cross members 221 and 220 at the corners of the elastic strap storage apparatus 200. The corners 230, 231, 232, 234 also include stops or portions which prevent elastic straps and specifically the hook ends of the elastic straps from slipping off the end of one of the cross members 210, 212, 220, 221. Cross member 222 is positioned about midway between the cross members 220 and 221. Cross member 222 is attached at about half the distance between the cross members 222 and 220. Cross member 222 is attached to cross member 210 and cross member 212. The cross member 222 can be used to store shorter elastic straps. The cross member 222 also provides for extra strength between the cross members 210 and 212. Also in the corners 220, 231, 232 and 234 are reinforcement portions which further strengthen the elastic strap apparatus. The triangular reinforcement portions carry the reference numerals 240, 241, 242 and 244. It should be noted that the dimensions of the embodiment of the elastic strap storage apparatus 200 is roughly square and that the first set of cross members 210 and 212 have the same dimension as the second set of cross members 220 and 221. The dimension is shown as D₂. The cross member 222 is attached about at the midway point to cross members 210 and 212. The dimension D₁ is approximately half the dimension D₂, as shown in FIG. 2.

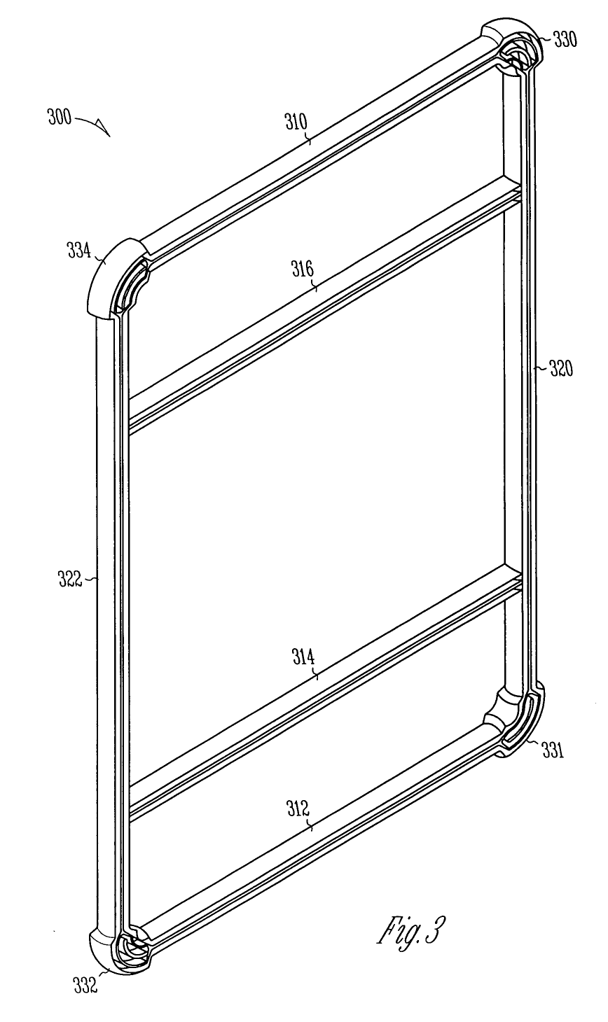

FIG. 3 is a perspective view of an elastic strap at storage apparatus 300, according to yet another example embodiment. The elastic strap storage apparatus 300 includes cross members 310, 312, 314 and 316, all of which are parallel or substantially parallel to one another. These cross members are attached to cross members 320 and 322. The cross members 320, 322 are parallel with one another, yet perpendicular to the cross members 310, 312, 314 and 316. Cross members 320 and 322 are attached to cross members 310 and 312 at a set of corners 330, 331, 332 and 334. Each of the corners are dimensioned so that they act as stops to prevent the hook ends of the elastic strap such as a bungee cord from passing over the end of the respective cross member. Comparing the embodiment shown in FIG. 3, or the elastic strap storage apparatus 300 to the other strap storage apparatus 100, 200, it can be seen that the dimensions, or outside dimensions, of the elastic strap storage apparatus form a rectangle. Thus, elastic straps of various sizes can be stored on the particular strap apparatus by either placing an elastic strap or hooking an elastic strap to cross member 310 and 312, or by hooking elastic strap member between the cross members 316 and 314. It should also be remembered that other elastic straps can be attached to the cross members 320 and 322. The spacings between the various cross members are set so that certain standard lengths of bungee cords or elastic straps can be stored on the elastic strap apparatus 300.

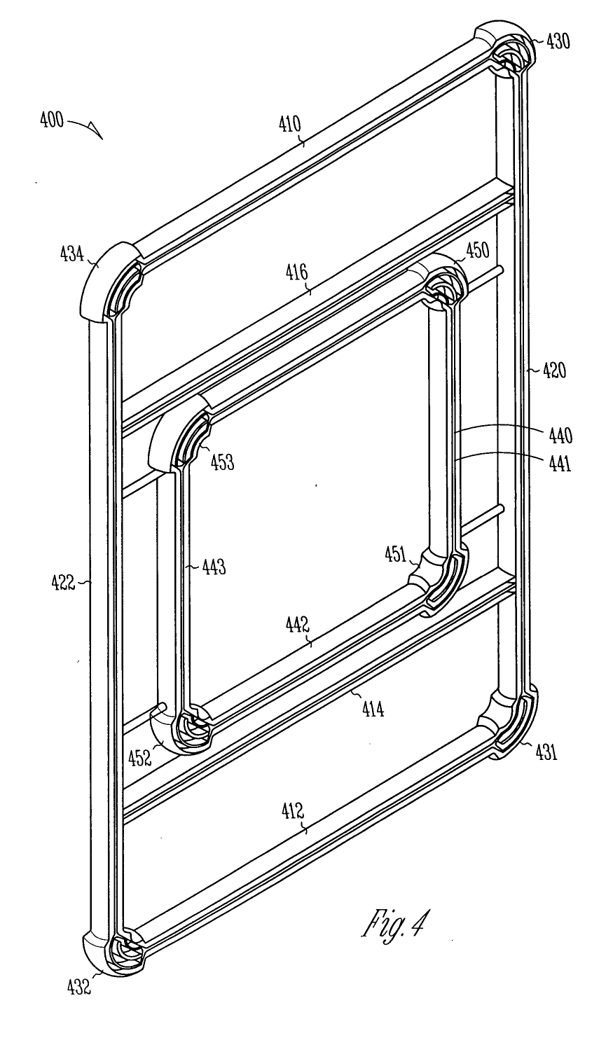

FIG. 4 is a perspective view of an elastic strap apparatus 400 according to an example embodiment. In this particular example embodiment, there are cross members 410, 412, 414 and 416. The cross members 412, 414, 416 and 410 are all substantially parallel with one another. Each of the cross members 410, 412, 414 and 416 are attached to another set of parallel cross members 420 and 422. The outer perimeter of the elastic strap holding apparatus 400 includes the cross members 410, 412, 420 and 422 attached to one another at the corners 430, 431, 432, 434. Each of the corners includes a stop or end having a diameter that is larger than the diameter of a hook associated with an elastic strap. Also included is an inner square. The inner square 440 is attached between the cross members 414 and 416 and also in between the cross members 420 and 422. The inner square strap holder 440 includes a first cross member 441, a second cross member 442, a third cross member 443, and a fourth cross member 444. These cross members 441, 442, 443 and 444 are attached to one another at the corners of the inner square 440. The corners carry the reference numerals 450, 451, 452 and 453. The inner square 440 is attached to the cross members 420 and 422 with relatively small diameter connections. The inner square can then be removed from the outer square by clipping the relatively small diameter connections. As a result, two elastic strap holders can be formed in one mold. The embodiment of the elastic strap storage apparatus 400 show elastic straps of various sizes can be held between various sets of cross members.

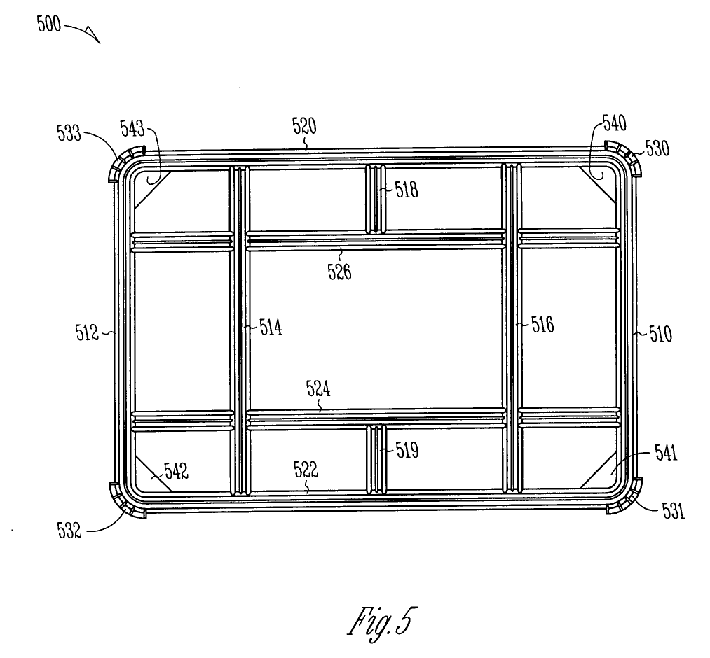

FIG. 5 is another top view of an elastic strap storage apparatus 500, according to an example embodiment. The elastic strap storage apparatus 500 includes a first cross member 510, a second cross member 512, a third cross member 514 and a fourth cross member 516, which are substantially parallel with one another. These are attached to another set of cross members 520 and 522, which are also parallel to one another but perpendicular or substantially perpendicular to the cross members 510, 512, 514 and 516. The cross members 510, 522, 512 and 520 are attached to one another at the corners 530, 531, 532, and 533. The corners include a stop or portion that is oversized with respect to the cross members 520, 510, 522, and 512 so as to prevent the hook end of an elastic strap or bungee cord from going past the corner or end 530, 531, 532, 533. Each corner also includes a reinforcing plate or triangular reinforcing plate 540, 541, 542, and 543. In addition, there are also supports 518 and 519 which are parallel to cross members 510, 512, 514, and 516. The extra support 518 is attached between cross member 520 and cross member 526 while support 519 is attached to cross member 524 and cross member 522.

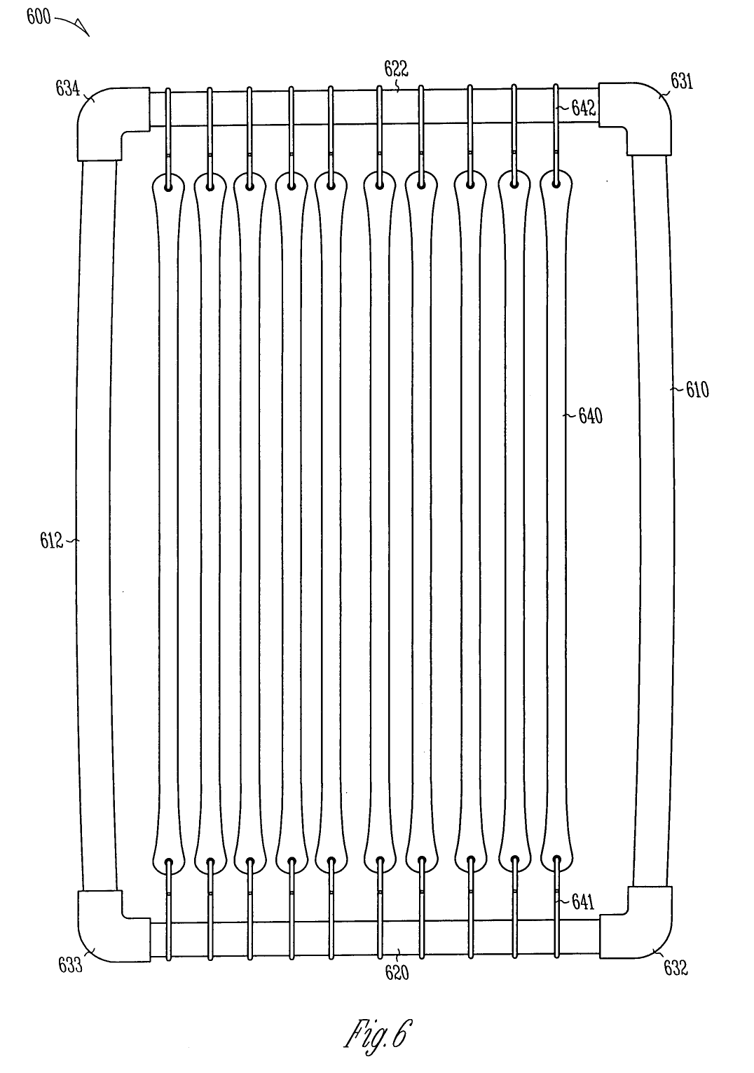

FIG. 6 is a top view of an elastic strap apparatus with elastic straps attached, according to an example embodiment. The elastic strap apparatus 600 includes cross members 610 and 612, which are held apart from one another by cross members 620 and 622. The cross members 610, 612, 620, and 622 are attached to one another at the corners 631, 632, 633, 634. Each of the corners 631, 632, 633 and 634 includes a stop or end having a diameter which is larger than a hook end 641 or 642 of an elastic strap 640. The elastic straps are stored by hooking one end 642 of each of the straps 640 to the cross member 622 and by attaching the other end 641 of the elastic strap 640 to the cross member 620. The distance between the cross member 620 and 622 are spaced so as to hold each elastic strap with a slight amount of tension in the strap.

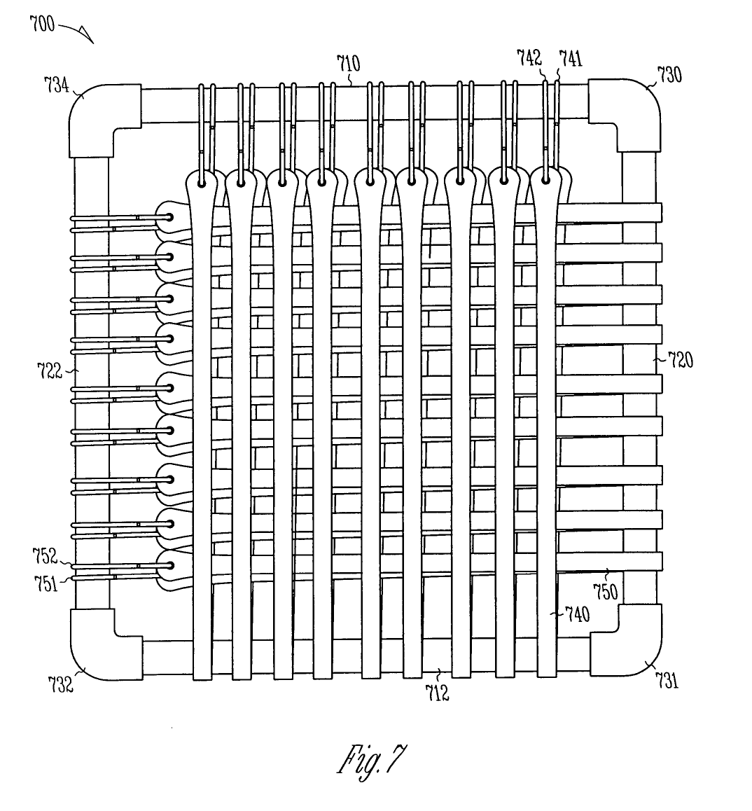

FIG. 7 is a top view of an elastic strap storage apparatus 700 with elastic straps attached, according to another example embodiment. The elastic strap storage apparatus 700 includes cross members 710, and 712, which are attached to another or second set of cross members 720, 722. Each of the cross members 710, 712, 720, 722 are attached to each other at the corners 730, 731, 732 and 734. Each of the corners also includes a stop which prevents hook ends of an elastic strap from passing over the end of the respective cross member 710, 712, 720, 722. One elastic strap 740 having a first end 741 and a second end 742 is attached to the elastic strap storage apparatus 700 by attaching a first end 741 to cross member 710, then wrapping the strap over the cross member 712 and attaching the second end 742 also to the cross member 710. There are a number of straps that can be attached this way along the length of the cross member 710 and 712. Another set of straps or elastic straps such as an elastic strap 750 is attached in the same fashion to the cross member 722 and 720. In other words, the first end 751 of the strap 750 is attached to the cross member 722. The strap is then wrapped over the cross member 720 and the second end 752 is attached to the same cross member 722. Thus, it can be seen that a number of straps can be attached transversed to one another, as shown in FIG. 7.

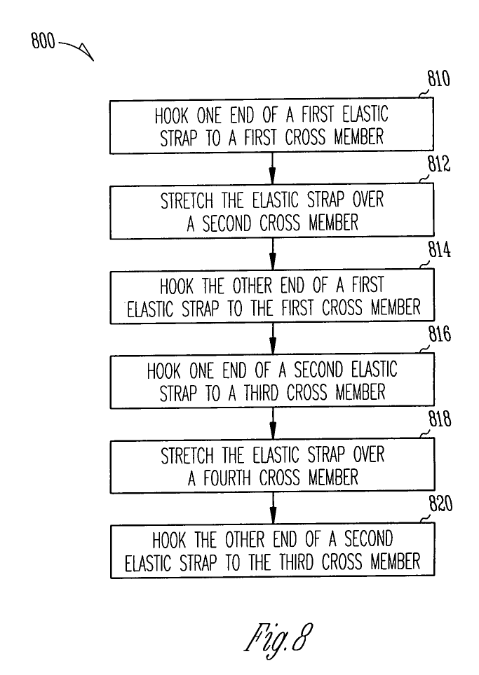

FIG. 8 is a flow chart of a method 800 for using an elastic strap storage apparatus, according to an example embodiment. The method 800 for storing elastic straps includes hooking one end of a first elastic strap to a first cross member 810, stretching the elastic strap over a second cross member 812, and hooking the other end of a first elastic strap to the first cross member 814. In some embodiments, the method 800 further includes hooking one end of a second elastic strap to a third cross member 816, stretching the elastic strap over a fourth cross member 818, and hooking the other end of a second elastic strap to the third cross member 820. In one embodiment, the second elastic strap traverses the first elastic strap. The first set of cross members, in some embodiments, is substantially perpendicular to the second set of cross members. As a result, the first elastic strap is substantially perpendicular to the second elastic strap. Of course, a plurality of straps may be attached to the first cross member and the second cross member and a plurality of straps may be attached to the third cross member and the fourth cross member. The result is a elastic strap storage apparatus holding a plurality of elastic straps, such as is shown in FIG. 7.

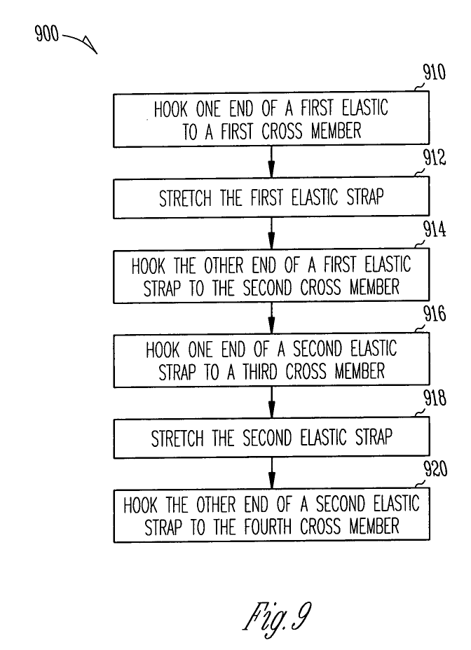

FIG. 9 is a flow chart of a method 900 for using an elastic strap storage apparatus, according to an example embodiment. The method 900 for storing elastic straps includes hooking one end of a first elastic strap to a first cross member 910, stretching the first elastic strap 912, and hooking the other end of a first elastic strap to the second cross member 914. The method would result in an elastic strap storage apparatus populated with straps such as the one shown in FIG. 6. In some embodiments, the method 900 further includes hooking one end of a second elastic strap to a third cross member 916, stretching the elastic strap 918, and hooking the other end of a second elastic strap to the fourth cross member 920. In one embodiment, the second elastic strap traverses the first elastic strap. The first cross member and the second cross member (first set of cross members), in some embodiments, is substantially perpendicular to the third cross member and the fourth cross member (second set of cross members). As a result, the first elastic strap is substantially perpendicular to the second elastic strap. Of course, a plurality of straps may be attached to the first cross member and the second cross member and a plurality of straps may be attached to the third cross member and the fourth cross member.

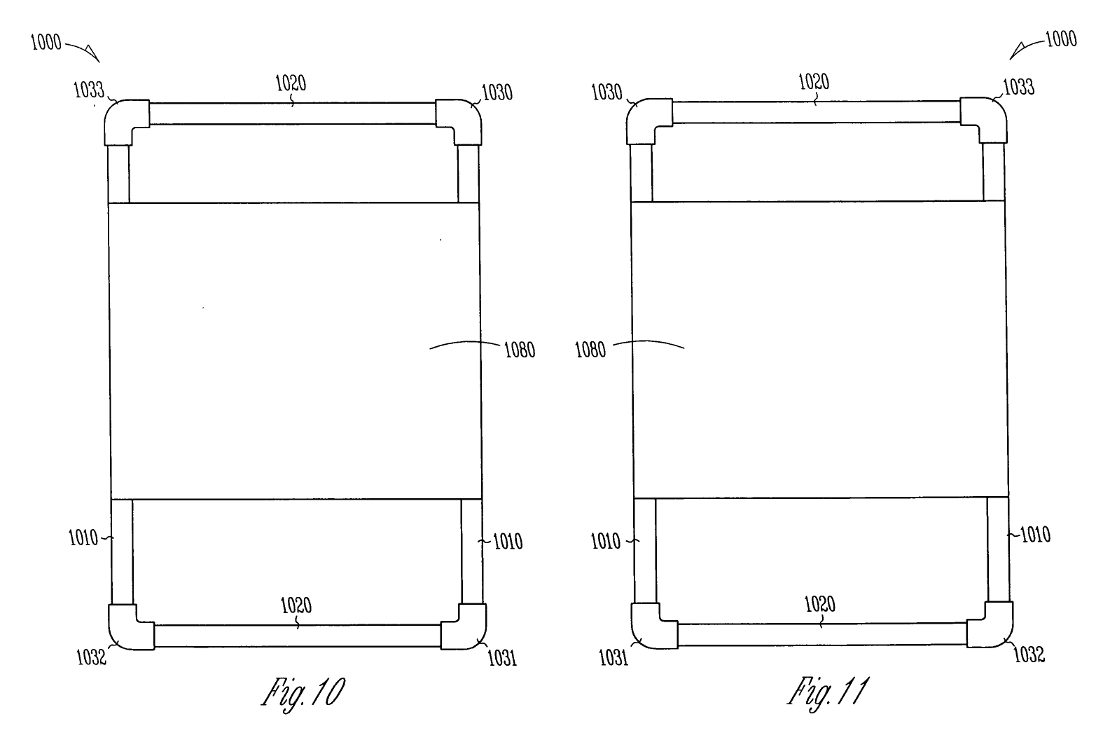

FIG. 10 is a front view of an elastic strap storage apparatus kit 1000, according to an example embodiment. FIG. 11 is a back view of an elastic strap storage apparatus kit 100, according to an example embodiment. The kit 1000 kit includes an elastic strap storage apparatus 1001 including: a first set of cross members 1010, and a second set of cross members 1020 attached to the first set of cross members 1010 so that the first set of cross members 1010 and the second set of cross members 1020 have stops 1030, 1031, 1032, 1033 on each end of the cross members. The kit 1000 also includes a set of instructions 1080 for using the elastic strap storage device 1000. In one embodiment, the instructions are attached to one of the first set of cross members 1010 or the second set of cross members 1020 (as shown in FIG. 10). In another embodiment, the instructions are attached to both of the first set of cross members 1010 or the second set of cross members 1020. In yet another embodiment, the instructions are separate from the first set and second set of cross members. In some embodiments, the instructions include marketing and advertising materials and a trade name. In some embodiments, the kit may include one or more elastic straps or bungee cords which can either be attached or unattached to the elastic storage unit. The kit 1000 may also include a plurality of elastic straps. In some embodiments, the kit 1000 may be shrink wrapped to complete packaging.

An elastic strap storage apparatus including a first set of cross members, and a second set of cross members attached to the first set of cross members. The first set of cross members and the second set of cross members have stops on each end of the cross member. The stops are adapted to prevent an open hook of an elastic strap from passing over the stop. The elastic strap storage apparatus can have various dimensions. In one embodiment, the first set of cross members are spaced at a distance slightly longer than an untensioned elastic strap. In another embodiment, the first set of cross members are spaced at a distance of about half the length of an untensioned elastic strap. In still another embodiment, the first set of cross members are spaced so that an elastic strap hooked onto the cross members will be in tension. In one embodiment, the first set of cross members are substantially parallel to one another, and the second set of cross members are substantially parallel to one another. In still another embodiment, the first set of cross members are substantially perpendicular to the second set of cross members. In some embodiments, the elastic strap storage apparatus also includes a third set of cross members positioned to be more closely spaced than at least one of the first set of cross members or second set of cross members. In still another embodiment, the elastic strap storage apparatus also includes a fourth set of cross members positioned to be more closely spaced than the other of the first set of cross members or the second set of cross members.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

1. An elastic strap storage apparatus comprising:
a first set of cross members; and
a second set of cross members attached to the first set of cross members so that the first set of cross members and the second set of cross members have stops on each end of the cross member.
